(19) United States
(12) Patent Application Publication
(10) Pub. No.: US 2013/0130398 A1
(43) Pub. Date: May 23, 2013

(54) SENSORS AND METHODS FOR DETECTING PEROXIDE BASED EXPLOSIVES

(71) Applicant: Ling Zang, Salt Lake City, UT (US)

(72) Inventor: Ling Zang, Salt Lake City, UT (US)

(73) Assignee: University of Utah, Salt Lake City, UT (US)

(21) Appl. No.: 13/510,768

(22) PCT Filed: Nov. 19, 2010
(86) PCT No.: PCT/US2010/057393

§ 371 Date: Sep. 21, 2012

Related U.S. Application Data
(60) Provisional application No. 61/263,233, filed on Nov. 20, 2009.

(51) Int. Cl. G01N 21/78

(52) U.S. Cl. CPC G01N 21/783
USPC 436/128; 536/20; 556/9; 8/188; 422/86; 436/135

(57) ABSTRACT

Methods, compositions, and systems for detecting explosives is disclosed and described. A sensor for detecting explosives can comprise a porous hydrophilic material modified with a titanium oxo compound having the following structure (I) where L is a ligand. Additionally, the porous hydrophilic material can be capable of detecting hydrogen peroxide vapor by complexing the titanium oxo compound and the hydrogen peroxide to provide a color change.

### RELATED APPLICATIONS

This application claims the benefit of copending U.S. Provisional Patent Application Ser. No. 61/263,233 filed on Nov. 20, 2009, which is hereby incorporated by reference in its entirety.

### GOVERNMENT INTEREST

This invention was made with government support under Grand #CBET730667 awarded by the National Science Foundation, and Grant #2009-ST-108-LR0005 awarded by the U.S. Department of Homeland Security. The government has certain rights to this invention.

### BACKGROUND OF THE INVENTION

Explosive devices can be difficult to detect as they can contain a variety of materials. In particular, many explosive detection systems focus on conventional explosives and generally do not detect peroxide based explosives. Currently there are several sensor systems or devices commercially available for peroxide explosives detection, including those built on chromatography, mass spectrometry and enzyme catalysis. Various methods of detection can include requiring a sample of the object material to be tested. Additionally, many are directed towards chemical identification, for which the integrated multistep instrumentation procedures are often time-consuming, taking minutes or even tens of minutes, and intrusive. Such methods and systems are not suited for expedient, onsite explosives screening or monitoring, particularly when moving individuals or vehicles are involved. Detection of these explosives through direct sensing of the peroxide compounds remains difficult mainly due to the weak oxidizing power (weak electron affinity) and lack of nitro-groups, which prevent the detection through fluorescence sensing (usually based on electron transfer quenching) and the conventional electronic detection systems, respectively.

### SUMMARY OF THE INVENTION

A sensor for detecting explosives can comprise a porous hydrophilic material modified with a titanium oxo compound having the following structure:

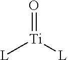

where L is a ligand. The porous hydrophilic material can be capable of detecting hydrogen peroxide vapor by complexing the titanium oxo compound with the hydrogen peroxide to provide a color change.

A method for detecting explosives can comprise placing a porous hydrophilic material modified with a titanium oxo compound in an area having hydrogen peroxide vapor, where the titanium oxo compound can have the following structure:

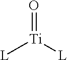

where L is a ligand, where the porous hydrophilic material is capable of detecting of the hydrogen peroxide vapor by complexing the titanium oxo compound with the hydrogen peroxide to provide a color change, and identifying the color change.

A system for detecting explosives can comprise a porous hydrophilic material modified with a titanium oxo compound having the following structure:

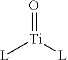

where L is a ligand; where the porous hydrophilic material is capable of detecting hydrogen peroxide vapor by complexing the titanium oxo compound with the hydrogen peroxide to provide a color change; and a colorimetric detector associated with the porous hydrophilic material configured to measure the color change.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. Nonetheless, the invention will be described and explained with additional specificity and detail through the use of the accompanying drawings in which:

FIG. 1 shows a schematic for self-assembly of various cyclic scaffolds in accordance with an embodiment of the present invention;

FIG. 2 shows (A) 1D self-assembly through columnar intermolecular π-π stacking; (B) a TEM image of the nanofibers self-assembled from the same tetracycle scaffold shown in FIG. 3; (C) an AFM image of ultrathin nanofibers fabricated from the same hexacycle scaffold shown in FIG. 3; and (D) AFM height profile showing the diameter of the nanofibers of (C);

FIG. 3(A) shows a photograph of a nanofibril structures (imaged with a Leica DMI4000 optical microscope) obtained from synthesis of perylene modified chitosan;

FIG. 3(B) the schematic of a synthesis of perylene modified chitosan and self-assembly into the nanofibril structures;

FIG. 4 is a photograph of various silica-gel strips comprising a porous hydrophilic material modified with a titanium oxo compound exposed to a peroxide compound in accordance with an embodiment of the present invention;

FIG. 5 is an absorption spectra for a silica thin film having a Ti-oxo compound thereon in accordance with an embodiment of the present invention;

FIG. 6 is an optical photograph of a cellulose fibril network in accordance with an embodiment of the present invention;

FIG. 7 is a UV-vis absorption spectra of a water solution of the titanyl oxalate (3.9×10⁻⁴ M) before (black-dotted) and after (gray) addition of 0.04 wt % H₂O₂ in accordance with an embodiment of the present invention;

FIG. 8 are photographs of a cellulose fibril network loaded with 100 μmol of ammonium titanyl oxalate before (A) and after (B) exposure to vapor of hydrogen peroxide (35 wt % H₂O₂ solution) for 5 min in accordance with an embodiment of the present invention;

FIG. 9 is a series of plots of Δb (defined in the CIELAB color space system as color change between yellow and blue) vs. Δt for varying amounts (μmol) of titanyl salts in accordance with an embodiment of the present invention;

FIG. 10 shows a plot of color change (Δb) recorded at three time intervals (20, 100, 240 s) as a function of the load of titanyl salt with an additional plot (right axis) of the initial color change (formation) rate (value of Δb/Δt at t=0, as obtained from FIG. 9) in accordance with an embodiment of the present invention;

FIG. 11 is a series of plots of Δb (defined in the CIELAB color space system as color change between yellow and blue) vs. Δt for various vapor pressures of hydrogen peroxide in accordance with an embodiment of the present invention;

FIG. 12 is a plot of Δb/Δt vs. vapor pressure of H₂O₂ in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It must be noted that, as used in this specification and the appended claims, the singular forms “a,” “an,” and “the” include plural referents unless the context clearly dictates otherwise. Thus, for example, reference to “a compound” includes one or more of such materials, reference to “an additive” includes reference to one or more of such additives, and reference to “a contacting step” includes reference to one or more of such steps.

Definitions

In describing and claiming the present invention, the following terminology will be used in accordance with the definitions set forth below.

As used herein, the term “substantially” or “substantial” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still contain such an item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

It has been recognized that it would be advantageous to develop a sensor for hydrogen peroxide vapor detection and analysis which can offer simple operation and quick results. The inventors have recognized that hydrogen peroxide can be taken as the signature compound of triacetone triperoxide (TATP) and other peroxide explosives because hydrogen peroxide, as a major reaction precursor (commercially available in water solution, e.g., 35 wt %) used in manufacture of the peroxide explosives, always exists as an impurity in the products, particularly crude homemade ones. TATP is one of the few explosives that can be explosive when wet or even kept under water, thereby removing the need of sophisticated purification of the product. Notably, such characteristics provide practical reasons why TATP and the analogous peroxides are highly favored by terrorists. Additionally, the explosives can be made by a simple one-step mixing process, and can provide products that are just as powerful as highly purified ones. As a consequence, water and hydrogen peroxide (which coexists with water) are common impurities present in such peroxide explosives. These explosives are essentially as deadly as conventional high explosives, but since they can be manufactured cheaply and easily at home from off-the-shelf ingredients, they are often used by terrorists and insurgents for making improvised explosives devices (IEDs). Notably, detection of these explosives through direct sensing of the peroxide compounds remains difficult mainly due to the weak oxidizing power (weak electron affinity) and lack of nitro-groups, which prevent the detection through fluorescence sensing (usually based on electron transfer quenching) and the conventional electronic detection systems, respectively. As such, the present inventors have discovered compositions and methods utilizing trace vapor hydrogen peroxide to detect explosive materials. Moreover, the inventors have recognized that hydrogen peroxide molecules can also be produced from the chemical decomposition of peroxide explosives, particularly under UV irradiation, allowing for the additional means and increased sensitivity for detecting explosives.

Compared to the conventional sensing systems, the present sensors provide a class of simple, expedient technique for vapor detection and analysis. Development of such an efficient sensing technique that can instantly detect and identify hydrogen peroxide vapor will help strengthen the national defense capability (e.g., protecting our soldiers in the battlefields from IED attacks), as well as homeland security. The present sensors can allow nondestructive, standoff detection systems and cheap, disposable detection kits that enable response to the presence of peroxide explosives at a distanced location. Such a response, as indicated by formation of bright yellow color, can even be feasibly read out by naked eyes.

Additionally, the present inventors have recognized that by taking advantage of the high vapor pressure of peroxide compounds, a dual-mode sensor can be designed and operated through vapor sampling of the peroxide explosives.

In one embodiment, a sensor for detecting explosives can comprise a porous hydrophilic material modified with a titanium oxo compound having the following structure:

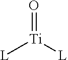

where L is a ligand. Additionally, the porous hydrophilic material can be capable of detecting hydrogen peroxide vapor by complexing the titanium oxo compound with the hydrogen peroxide to provide a color change.

Generally, the porous hydrophilic material can be a thin film or strip. In one embodiment, the porous hydrophilic material can comprise a cellulose fibril material. As such, the sensor can be disposable.

Generally, the colorimetric sensing of hydrogen peroxide is based on highly porous hydrophilic materials modified with titanium oxo compounds. Such compounds include Ti(IV) oxo complexes (>Ti═O, e.g. titanyl), which provide highly selective, strong binding with hydrogen peroxide. The Ti(IV) complex is intrinsically colorless (i.e., with no absorption in the visible region), whereas it turns to bright yellow upon complexation with hydrogen peroxide through formation of the Ti(IV)-peroxide bond, which exhibits strong absorption around 400 nm. The unique bright yellow color thus formed due to the Ti(IV)-peroxide bonding can be used as a visual signal indicative of the presence of hydrogen peroxide as well as with colorimetric detectors, as discussed herein. Notably, such complexation-induced color change is generally exclusively selective for hydrogen peroxide, with no color change observed in the presence of water, oxygen, common organic reagents or other chelating reagents such as carbonate, sulfonate, EDTA, oxalate, etc. The general reaction can be illustrated as follows:

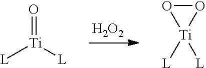

where the non-complexed Ti is colorless and the complexed Ti has color. The color is visually distinguishable and can often be a bright yellow.

Generally, the titanium oxo compound can be directly bonded to a substrate through coating or other methods. A surface coating or binding can be performed through electrostatic interaction or hydrogen bonding between the ligand L and the surface of the substrate including —OH, —COOH or any other moieties available on the surface. In one aspect, the titanium oxo compound can be bound to the surface through covalent bonding of the reactive ligand L to the surface moieties of the substrate. In another aspect, the surface can be bound through electrostatic interaction between a carboxylate ligand L, e.g. oxalate, and the surface, e.g. —OH groups of silica gel. Additionally, direct dispersion of a Ti(IV) solution into a porous matrix (e.g., filter paper or silica gel) can be done to associate the titanium oxo compound with a substrate. In one aspect, covalent-linking of the Ti(IV) complex onto a building block molecule can be used, followed by assembling the functionalized molecules into nanofibers, which can then be deposited onto a substrate to form a highly porous nanofibril film.

The porous films discussed herein can possess at least one of the following: 1) continuous pore channels, allowing for efficient diffusion of the gaseous molecules throughout the film matrix, making it possible to fabricate a thick film to increase the optical density and thus enhance the sensing accuracy; 2) strong hydrophilic (hygroscopic) surface enabling effective adsorption of hydrogen peroxide; 3) nanoscopic structure that allows for maximal distribution of the Ti(IV) oxo moiety at the surface, thus enabling maximal exposure to the gaseous analytes; 4) a chemical composition that can effectively stabilize the Ti(IV) complex by preventing it from hydrolysis into the inactive oxides; and 5) transparent and/or colorless optical property in the pristine state (i.e., before exposure to hydrogen peroxide) allowing for easy visual monitoring of the color change. In one embodiment, the porous films discussed herein can possess all of these qualities.

Generally, the porous hydrophilic material can be fabricated by depositing large numbers of nanofibers onto a substrate to form the thin film, where the nanofiber is surface-modified with the titanium oxo compound. Non-limiting examples of such materials can be cellulosic paper, filtration paper, silica gel, polymer film, woven polymer, and the like. Typical hydrophilic or water soluble polymer materials can be commercially available from Dow, including but not limited to, CELLOSIZE® hydroxyethylcellulose (HEC), ETHOCEL® ethylcellulose polymers, KYTAMER® PC polymers, METHOCEL® cellulose ethers, POLYOX® water soluble resins, and the like. In one aspect, a porous silica gel can have greater than 1000 m²/g surface area. In another aspect, these substrates can be substantially transparent. In one embodiment, transparent silica-gel films that possess highly porous structure can be used, for which the surface area can be above about 500 m²/g.

One non-limiting example of a substrate preparation is a silica gel made from hydrolysis of tetramethoxysilane in the presence of cationic surfactants. The pre-matured gel solution (or emulsion) thus prepared is suited for spin-coating onto a flat substrate such as glass that is desirable for optical sensing. Briefly, tetramethoxysilane can be hydrolyzed in an acidic aqueous solution (tetramethoxysilane:water controlled at 1:10) for about one hour. Due to the substoichiometric amount of water, only partial hydrolysis will be obtained, leading to formation of a homogeneous solution. To this solution can be added alkyltrimethylammonium chloride, a surfactant used as template for forming the porous structure. After reacting under ambient condition for certain amount of time, the solution thus obtained can be spin-coated onto a glass slide, followed by drying in air to allow evaporation of solvent and condensation of the silica. Transparent thin film will eventually be formed on the substrate. Depending on the spin speed, films of different thicknesses, ranging from a few microns down to submicron, can be obtained. The films thus made can be subject to calcination (ca. 450° C.) in air to remove the surfactants, allowing for formation of larger pore structures, which are conducive to expedient diffusion of gaseous analytes through the film matrix.

In one embodiment, the ligand can be selected from the group consisting of: acetylacetones, carboxylates, sulfates, hydroxyls (—OH), or any other ligands that can enable strong binding to the substrate materials surface either through electrostatic interaction, hydrogen bonding or covalent bonding between the ligand L and the materials surface. In one aspect, the ligand can be a substituted acetylacetone. In one embodiment, the ligand can be represented by the structures in Formula 1:

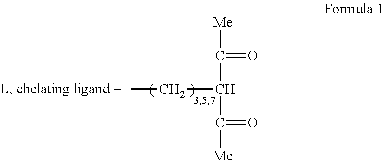

As discussed above, the sensors can provide exceptional sensitivity able to detect minute quantities of hydrogen peroxide vapor. In one embodiment, the hydrogen peroxide vapor can be less than 1 ppm. In another embodiment, the hydrogen peroxide vapor can be present in an amount of about 1 ppb to about 100 ppb. The sensitivity of the sensor to hydrogen peroxide vapor can be a function of the specific titanium oxo compound, as well as the concentration of the compound on the hydrophilic material. Although any concentration can be functional, as a general guideline about 50% to about 100% coverage of the surface binding sites can be suitable.

As discussed herein, the present sensors can detect hydrogen peroxide vapors from explosives. As such, in one embodiment, the sensor can detect peroxide based explosives. In another embodiment, the explosives can include a compound selected from the group consisting of triacetone triperoxide (TATP), diacetone diperoxide (DADP), hexamethylene triperoxide diamine (HMTD), and mixtures thereof.

In one embodiment, the porous hydrophilic material modified with the titanium oxo compound can provide a visual color change upon exposure to the hydrogen peroxide. In this approach, presence of an offending explosive could be qualitatively determined by a perceptible color change of the material. In another embodiment, the sensor can further include a colorimetric detector associated with the porous hydrophilic material configured to measure the color change. In this approach, the presence of peroxide can be quantified by correlation with a numeric or other scale. The colorimetric detector can be any suitable detector. Non-limiting examples of suitable detectors can include commercial color readers such as, but not limited to, CR-10 or CR-14 from Konica Minolta Sensing Americas, Inc.

In one embodiment, the sensor can be disposable (e.g. configured for a single use). In one alternative, the sensor can be a handheld device with the modified hydrophilic material oriented within a receiving port. Thus, the material can be removed and replaced after a predetermined time or when the material otherwise becomes unusable.

A method for detecting explosives can comprise placing a porous hydrophilic material modified with a titanium oxo compound in an area having hydrogen peroxide vapor; the titanium oxo compound having the following structure:

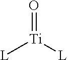

where L is a ligand, and identifying the color change. Additionally, the porous hydrophilic material can be capable of detecting of the hydrogen peroxide vapor by complexing the titanium oxo compound with the hydrogen peroxide to provide a color change.

In one embodiment, identifying the color change can be by visual inspection (e.g. a change to yellow). In another embodiment, identifying the color change can be by a colorimetric device. The measured color change can be correlated to a numerical or relative scale in order to assist in assessing risk level and/or determining proximity to the explosive. For example, a weak signal may indicate that the tested sample has merely been in recent contact with an explosive while not being a threat in and of itself. A strong signal may indicate an immediate threat and possible actual presence of a corresponding explosive material. Such gradation of signals can help the user to coordinate appropriate response for further investigation and/or management of the risk. Additionally, in one embodiment, the method can further comprise disposing of the porous hydrophilic material after use.

A system for detecting explosives can comprise a porous hydrophilic material modified with a titanium oxo compound as described herein; and a colorimetric detector associated with the porous hydrophilic material configured to measure the color change. Additionally, the sensor can be a dual mode sensor system. The system can further comprise a UV irradiation source for decomposing peroxide compounds into hydrogen peroxide vapor. As discussed above, two channels of vapor sampling can be employed, one attached with a UV irradiation source, one without. The former can be used for sampling the vapor of peroxide compounds (which can subsequently be decomposed into free hydrogen peroxide molecules by UV irradiation), while the latter can be used for collecting the hydrogen peroxide vapor directly leaked from the raw explosives. The hydrogen peroxide molecules thus collected from both the two channels can be subject to detection by the same colorimetric sensory film placed in the back of the device. With this dual-mode sensing, unprecedented sensitivity can be achieved, as well as increased reliability (to minimize false positives) in detection peroxide explosives, and the related IEDs.

### EXAMPLES

The following examples illustrate a number of embodiments of the present compositions, systems, and methods that are presently known. However, it is to be understood that the following are only exemplary or illustrative of the application of the principles of the present compositions, systems, and methods. Numerous modifications and alternative compositions, methods, and systems may be devised by those skilled in the art without departing from the spirit and scope of the present systems and methods. The appended claims are intended to cover such modifications and arrangements. Thus, while the present compositions, systems, and methods have been described above with particularity, the following examples provide further detail in connection with what are presently deemed to be the acceptable embodiments.

### Example 1

### Surface Modified Nanofibers

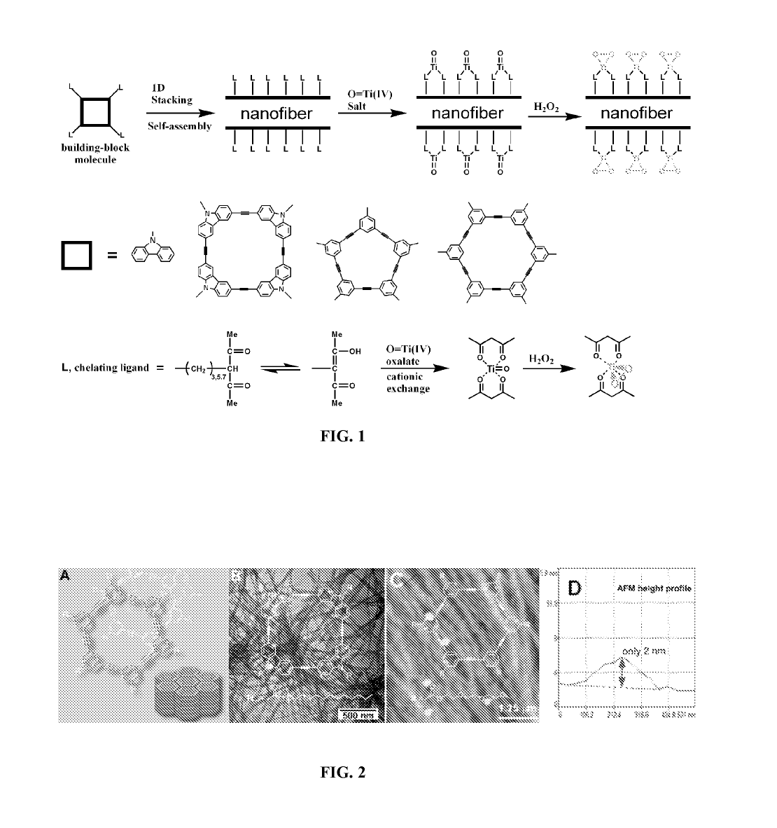

Surface modified nanofibers can be formed using any suitable technique. For example, nanofibril materials can be fabricated through self-assembly of building block molecules that are functionalized with Ti(IV) chelating ligands as illustrated in FIG. 1. This diagram shows the enhanced colorimetric sensing of H₂O₂ through surface functionalized nanofibers. Synthesis of the bromo-ended alkyl-linked acetylacetonate chelating ligand can be based on known methods, and coupling of the bromo-end to the building-block scaffold can follow the generally established SN1 reaction. Different lengths of the alkyl link between the central scaffold and the chelator can be synthesized. Deposition of large number of these nanofibers onto a substrate forms an efficient sensory material that can incorporate properties desired for vapor detection including: maximal exposure to the gaseous molecules, expedient diffusion of the molecules throughout the mesh-like film, and increased adsorption and accumulation of the gaseous molecules within the highly porous matrix. A combination of these properties can enable efficient vapor sensing of hydrogen peroxide.

Notably, the whole building block molecule can be chosen so as to assure the one-dimensional self-assembly leading to production of well-defined nanofibers. In one embodiment, the amphiphilic molecules noted in FIG. 1 (ended with the hydrophilic Ti(IV) chelating ligand) can be used. Indeed, ultralong nanofibers (in the length of millimeter) can be fabricated from an amphiphilic molecule. Upon processing in a hydrophilic solvent, the nanofibers fabricated from the amphiphilic molecules can be covered with high density of Ti(IV) chelating ligands. Impregnating these fibers in a Ti(IV) solution can result in a full coverage of the fiber surface with Ti(IV) complexes, leading to increased chemical contact with hydrogen peroxide.

Deposition of the surface-functionalized nanofibers onto a substrate can produce a mesh-like, highly porous film, which allows for maximal exposure to the gaseous analyte molecules, leading to increased adsorption and accumulation of the gaseous species within the porous matrix. The 3D continuous pore structure thus formed by the entangled piling of nanofibers enables expedient diffusion of the analyte molecules throughout the film matrix, facilitating the fast sensing response, in one aspect, in seconds or even milliseconds. Combination of these properties can enable efficient vapor sensing for hydrogen peroxide. Moreover, the nanofibril approach offers enormous flexibility and options for structural optimization of the sensory materials concerned both the pore size and surface binding property, for which the former can simply be adjusted by changing the fiber size, while the latter can be modulated through chemical modification of the building-block molecules.

### Example 2

### Molecular Scaffolds

Molecular scaffolds can also serve as nanofibril building-blocks. Rigid, planar π-conjugated molecules tend to assemble into 1D nanostructures (e.g., nanofibers) mainly through the columnar π-π stacking. Such an approach can be employed to fabricate well-defined nanofibers with controllable size and length. To maintain the fibril materials thus fabricated colorless (which is conducive to colorimetric sensing), small molecules with no visible absorption can be chosen as the building blocks. FIG. 1 shows several molecules which can be suitable. As evidenced by ab initio calculation (e.g., DFT), for all the molecules presented in FIG. 1, the electronic transition gap (HOMO-LUMO) is larger than 4.2 eV, i.e., only absorbing light irradiation of wavelength below 295 nm, far in the UV region. Although the HOMO-LUMO gap usually shrinks narrower upon molecular stacking into solid state, the optical response of the nanofibril materials thus fabricated should still remain in the UV region, showing colorless background.

FIG. 2 shows in (A) 1D self-assembly through columnar intermolecular π-π stacking. The lateral stacking offsets are omitted for clarity. FIG. 2(B) is a TEM image of the nanofibers self-assembled from the same tetracycle scaffold shown in FIG. 1. The self-assembly was carried out through the bilayer phase transfer method between chloroform and methanol. FIG. 2 (C) is an AFM image of ultrathin nanofibers fabricated from the same hexacycle scaffold shown in FIG. 1; the fabrication was performed on glass substrate using an in situ, surface-assisted self-assembly method. The diameter of the nanofiber, as measured by the AFM line scan shown in FIG. 2(D), was only 2 nm. Smaller nanofibers are generally conducive to enhancing the sensing efficiency owing to the increased surface area.

The nanofibers fabricated from these small conjugated molecules are optically transparent and colorless, desirable for development as colorimetric sensory materials. Additionally, through chemical synthesis, the Ti(IV) chelating ligands can be attached to the tetracycle scaffold (FIG. 1). Typical chelating ligands can include acetylacetonate, which has strong complexing with Ti(IV) oxo (>Ti═O). The adaptable chemical synthesis associated with acetylacetonate can facilitate chemical attachment of this ligand to the building-block molecules.

The synthesized building-block molecules can be fabricated into nanofibers through self-assembly in a polar, hydrophilic solvent, e.g., methanol, to assure the molecules will be assembled in a way with the Ti(IV) chelating end towards the external surface of nanofiber. The nanofibers thus fabricated can be impregnated in a solution containing Ti(IV) complexes to load the surface with Ti(IV) oxo moiety through cationic exchange (FIG. 1). The high surface density (concentration) of chelating ligands can allow high surface coverage of Ti(IV) oxo complexes simply due to the favorable shifting of the ionic exchange equilibrium.

Upon deposition onto a glass substrate, the entangled piling of nanofibers form a mesh-like, porous film, which usually possesses porosity on a number of length scales. When employed for vapor sensing, the porous film not only provides increased surface area for enhanced adsorption of gaseous molecules, but also enables expedient diffusion of guest molecules across the film matrix, leading to efficient probing of the gaseous molecules with both high sensitivity and fast time response.

Well-defined nanofibers with smaller sizes (cross-section ideally smaller than 100 nm) can be achieved. Larger size of fibers may cause significant light scattering, thus interfering the colorimetric sensing when a spectrophotometer is employed for the absorption measurement. Depending on the molecular structure and property, various solution-based self-assembly procedures can be used for the nanofibers fabrication, typically including solution dispersion, bilayer phase transfer, slow vapor transfer, seeded growth and sol-gel processing. Selection of solvents can also assure that the surface of the nanofibers fabricated therein are preferentially covered by the Ti(IV) chelating ligands, easing later-on loading of the Ti(IV) oxo complexes through ionic exchange.

### Example 3

### Polymer Scaffolds

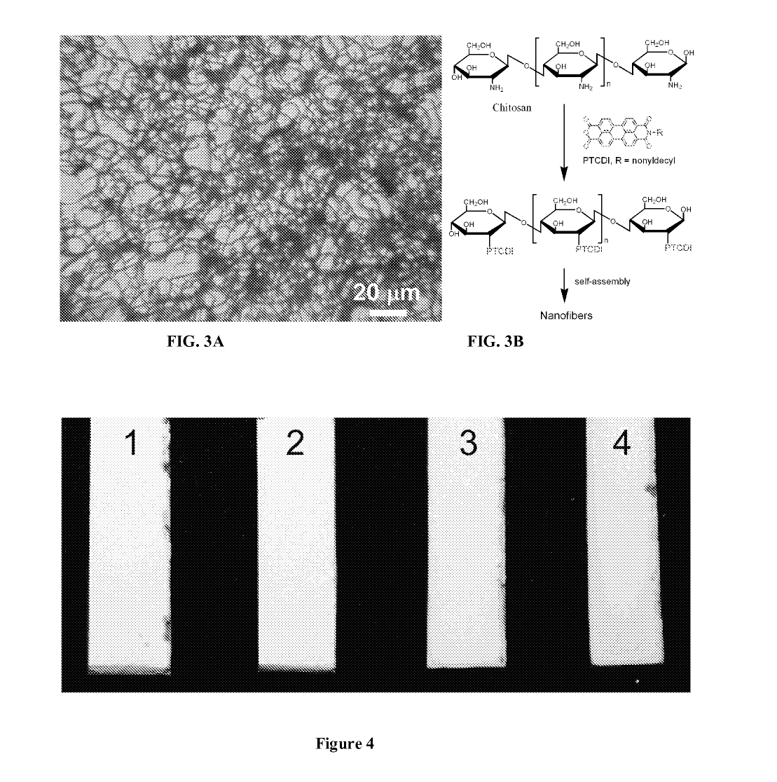

Another approach to fabricating the Ti(IV)-functionalized nanofibers is to use a polymer chain as scaffold, on to which the Ti(IV) chelating ligands can be feasibly attached through one-step chemical reaction as illustrated in FIG. 3. In this example, chitosan, a natural, bio-generated polymer, was used as the scaffold to fabricate the sensory nanofibers. The non-toxic property of chitosan, along with the biodegradability and biocompatibility, can eventually make the materials manufacturing a green, environment benign process. The abundance of amino moiety (—NH₂) within chitosan facilitates the chemical attachment of the Ti(IV) chelating ligand (e.g., acetylacetonate) to the polymer chain (FIG. 3), enabling high density surface loading of the Ti(IV) oxo complexes, thereby assuring improved sensing sensitivity.

FIG. 3 illustrates one specific embodiment of this general approach showing synthesis of perylene modified chitosan and self-assembly into nanofibril structures (imaged with a Leica DMI4000 optical microscope). The synthesis was carried out in melted imidazole at 100° C., where the amino moiety of chitosan were maintained as free base for effective coupling with the perylene monoanhydride. The self-assembly of nanofibril structure was carried out using a rapid solution dispersion method (from chloroform to methanol). The synthesis of acetylacetonate substituted chitosan (suited for loading with Ti(IV) complex) can be carried out by reacting the acetylacetonate chelating ligand (now terminated with a reactive bromo-moiety) with the amine moiety of chitosan, as schematically depicted below (scheme 1).

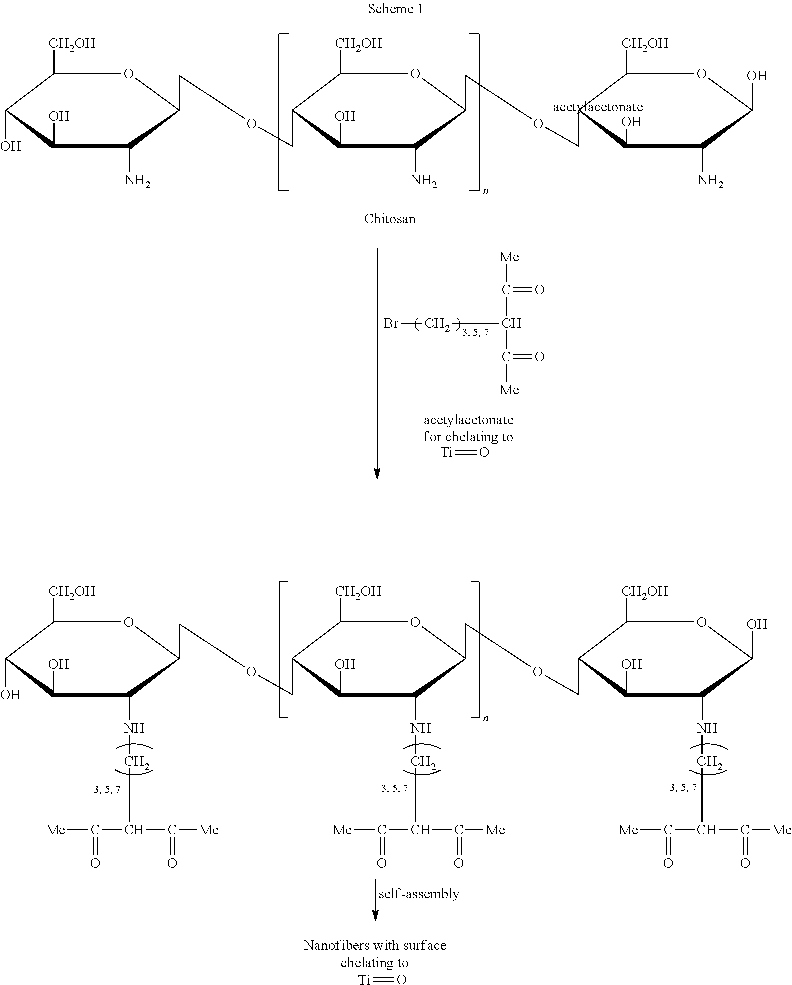

The semi-rigid chain of chitosan and the strong inter-chain hydrogen bonding facilitate nanofibril fabrication either through solution-based self-assembly or electro-spinning. Efficient nanofibril formation intrinsic to chitosan can remain after the chemical modification with the Ti(IV) chelating ligands; well-defined nanofibers can still be obtained upon optimization of the self-assembly condition (e.g., selection of solvents, temperature, etc.). Chitosan (at the amino sites) was modified with a perylene moiety, and successfully fabricated on the modified polymer into well-defined nanofibers as shown in FIG. 3. The red color of perylene chromophore enables easy imaging of the global nanofibril morphology using conventional optical microscope, allowing instant screening of large amount of samples (compared to that employing electronic microscopes), and thus facilitating the optimization process for the nanofibril fabrication. Considering the fact that the Ti(IV) chelating ligand is much smaller than the whole perylene molecule (including the side-chain) and may cause much less steric interference for the molecular assembly, the nanofibril fabrication with the chitosan modified by the Ti(IV) chelating ligand can be much easier and more straightforward, and the nanofibers thus fabricated can be well-defined and smaller size. By impregnation in a solution containing Ti(IV) oxo salt, the nanofibers can be fully coated with the Ti(IV) oxo complex.

### Example 4

### Ti(IV) Oxo Material Fabrication

The colorimetric vapor sensing of hydrogen peroxide has been successfully performed by loading Ti(IV) oxo complexes (>Ti═O) into two commercial porous materials, filtration paper and silica gel (the one commonly used in thin film chromatography, TLC). Both the two materials are of purely white background, brining no interference to the colorimetric sensing, i.e., the yellow color formation due to the Ti(IV)-peroxide complexation can thus be clearly unveiled.

The colorimetric sensing of hydrogen peroxide vapor shown in FIG. 4 was performed on silica-gel strips (cut from the TLC plate obtained from Selecto Sci.) incorporated with a Ti(IV) oxo complex, ammonium titanyl oxalate. The sensor strip (or plate) was fabricated as follows: a silica-gel strip cut from the commercial plate was impregnated with 0.35 M aqueous solutions of ammonium titanyl oxalate for one hour, followed by drying in air or elevated temperature around 50° C.

Bright yellow color emerged upon exposing the strip thus prepared to a vapor of hydrogen peroxide. Depending on the vapor pressure of hydrogen peroxide, the response time (the time needed to form visualizable yellow color for naked eyes) ranges from instant (subsecond) for 35 wt % hydrogen peroxide (vapor pressure 170 ppm), to a few minutes for 3.5 wt % hydrogen peroxide (vapor pressure 17 ppm), and to a few tens of minutes for 0.35 wt % hydrogen peroxide (vapor pressure 1.7 ppm). Strip 1 shows the pristine strip as a baseline. Strip 2 shows the strip after exposure to the vapor of various organic solvents (e.g., chloroform, hexane, acetone, alcohols, acids, etc.), and dipped into the pure liquid of di-tert-butyl-peroxide. Strip 3 shows the strip after 5 seconds exposure to the vapor of 35 wt % H₂O₂ (ca. 170 ppm). Strip 4 is the strip after 15 seconds exposure to the vapor of 35 wt % H₂O₂. In light of the strong color change shown in FIG. 4, the detection limit could easily go down to sub-ppm, or the ppb range if the color change was detected by a colorimeter (based on electronic photon detector), which enables monitoring very light color change compared to naked eyes. Moreover, the colorimetric sensing with the silica-gel substrate demonstrated high selectivity to hydrogen peroxide, with no color formation upon exposure to the vapor of various organic solvents (e.g., chloroform, hexane, acetone, alcohols, acids, etc.).

### Example 5

### Absorption of Varying Peroxide Vapor Concentrations

FIG. 5 shows the absorption spectra of a silica thin film upon exposure to hydrogen peroxide vapor from three different concentrations of solution: 35, 3.5 and 0.35 wt %. The pristine film was transparent and colorless, and had no absorption in the wavelength range as shown as a baseline in the plot. The vapor exposure time was 5 minutes for all the three tests as presented. The vapor pressure of hydrogen peroxide (in ppm, at 20° C.) was estimated by fitting reported data from the literature. The Ti(IV) modified silica thin film was prepared by hydrolysis of tetramethoxysilane in an acidic water solution (tetramethoxysilane:water controlled at 1:10, ˜5 drops of 0.1 M HCl added to a total volume of 2 mL mixture), followed by addition of 5 drops each of octadecyltrimethyl ammonium chloride (1 g/mL in water) and 1.0 M ammonium titanyl oxalate aqueous solution. The emulsion-like gel thus formed was spin-cast onto a glass slide at 6000 rpm, followed by drying in air at 110° C. for 10 minutes. As shown in FIG. 5, the absorption band is broad in the range of 350 to 450-500 nm, but centered around 400 nm. This range wavelength of absorption corresponds to appearance of yellow color.

Before use for sensing, the film was dried in air at about 110° C. to remove all the water solvent, whereas no high temperature calcination was taken to avoid chemical damage or decomposition caused to the Ti(IV) complex. The vapor sensing of hydrogen peroxide was performed with a spectrophotometer by recording the whole absorption spectrum of the Ti(IV) doped film. With a regular PMT photon detector attached to the spectrophotometer, the sensor film could already detect the saturated vapor from the 0.35 wt % hydrogen peroxide aqueous solution, corresponding to a vapor pressure of as low as 5 ppm. The film employed in the sensing test presented in FIG. 5 was not calcined at high temperature, and thus still contained the full amount of surfactants. The presence of these surfactants likely restrained the pore size and the vapor accessibility of the film such that improved sensitivity can be expected from a calcined sensor film. Furthermore, increased loading of the Ti(IV) complex can be achieved by impregnation performed under acidic condition (pH<pzc), under which the surface of silica will be protonated and the positively charged surface will facilitate the loading of anionic Ti(IV) complex through electrostatic interaction.

As shown in FIG. 5, the films all showed an increase in absorbance over the baseline (which is the pristine film) showing that the films successfully detected the presence of hydrogen peroxide vapor from 1 ppm to 170 ppm.

### Example 6

### Prophetic Sensor Materials

Tetraethoxysilane is mixed with ethanol, water and HCl at molar ratios of 1:3:8:5×10⁻⁵, and refluxed at 60° C. for 1.5 hour, followed by addition of appropriate amount of water and HCl so as to increase the concentration of HCl up to ca. 7 mM. The sols thus obtained are stirred at room temperature for about 15 min, followed by aging at an elevated temperature of 50° C. for about 15 min. After dilution with ethanol, the sols are added a surfactant, cetyl trimethylammonium bromide, in a amount corresponding to concentrations in the range of 0.03-0.11M (1.5-5.0 wt %). Thin films are prepared on a glass substrate by dip-coating, for which the film thickness is simply controlled by adjusting the dip-coating speed, typically ranging from 1 to 10 cm min⁻¹. During dip-coating, the preferential evaporation of ethanol leads to progressive enrichment of water, HCl and the non-volatile components (silica and surfactant). This method partially relies on in situ surfactant enrichment through solvent evaporation to exceed the critical micelle concentration, for which the mesophase is usually developed during the last few seconds of film deposition. With this method, one can selectively tailor the film morphology (developed during the solvent evaporation) simply by varying the starting concentration of surfactant.

The 3D porous network intrinsic to the materials thus prepared facilitates the surface modification with Ti(IV) through impregnation in an aqueous solution. The increased pore accessibility expedites the surface ionic exchange process, allowing examination of various Ti(IV) oxo complexes regarding the different binding affinity and coordination geometry with silica surface, aiming to maximize the surface density of Ti(IV). Moreover, the enhanced pore exposure to gaseous phase can enhance the intake, inter-channel diffusion and thus accumulation of gaseous analytes within the materials, eventually leading to increased sensing sensitivity.

Notably, for both the two types of silica gels (1D and 3D porous structure), one consideration in improving the sensing sensitivity is to increase the surface loading of the Ti(IV) oxo complex. Although the loading can be improved by adjusting the pH and increasing the concentration of Ti(IV) salts, the surface density of Ti(IV) may be limited below maximum, as the surface ionic exchange with the Ti(IV) complex will still be controlled by the binding-debinding equilibrium, which in turn is determined by the local electrostatic field, as well as the limited pore size. To this end, the co-sol-gel procedure (as described in Example 5) can provide an alternative way to produce the sensory materials, in which the Ti(IV) oxo complexes can be homogeneously distributed within the silica film and the surface loading of Ti(IV) can be feasibly maximized by increasing the starting concentration of Ti(IV) salts. The presence of cationic surfactants can strengthen the dissolution of anionic Ti(IV) complexes, specifically within the inter-layer region between silicate and surfactant phase, thereby leading to increased intake and distribution of Ti(IV) throughout the film matrix. However, for the film fabricated by this co-sol-gel procedure, there may be no way to remove the surfactants, since high temperature calcination will also destroy the Ti(IV) complexes. To keep the surfactants, while still maintaining the effective pore access, the pore size of the materials can be large enough to accommodate strong adsorption and expedient diffusion of gaseous analytes.

### Example 7

### Prophetic Sensor Materials

This is another synthetic approach to fabrication of silica film with adjustable pore sizes using lyotropic L₃ phase as template. In this method, the lyotropic L₃ phase of surfactants is used as a template to form nanoporous monolithic silica materials that possess continuously adjustable pore size and are fabricated into thin films on glass substrate. The 3D nature of the continuously connected pore networks facilitates the gaseous exposure from the film surface, enabling enhanced adsorption and accumulation of gaseous analytes in the similar manner as expected for the above stated 3D porous silica gels. A pyridine substituted surfactant, cetylpyridinium chloride, is chosen as the L₃ phase. Appropriate amount of the surfactant is mixed with hexanol and HCl, so as to result in a solution with surfactant-to-hexanol molar ratio of 1.15, water weight fraction ranging from 55 to 95%, and an initial pH of 0.7. The L₃ phase is formed readily for each sample, achieving equilibrium within 2 days. Tetramethoxysilane is then be added to the equilibrated L₃ phase at a fixed molar ratio of 1:4 to the water component. After the hydrolysis of tetramethoxysilane is completed (usually a rapid process), the mixture is sealed and kept in an oven at 60° C. for gelation, which usually takes several hours depending on the volume of solvent used. The freshly prepared gel is fluidic enough for spin-casting onto a substrate to make thin films. The film thus deposited is cured in an oven at 60° C. for days to dry out the solvent and increase the materials strength.

The silica materials thus prepared are highly porous, with adjustable pore size ranging from a few to over 35 nm, while still maintaining optically isotropic, transparent and colorless, ideally suited for colorimetric sensing. Moreover, the large, bicontinuous pore structure allows for full access to both the solution and gaseous analytes, for which it is not even necessary to remove the surfactants (to allocate more pore space). This will enable loading the Ti(IV) oxo complex through a co-sol-gel process by adding the Ti(IV) solution together with the tetramethoxysilane, in a similar manner as described in Example 5. This way, homogeneous distribution of Ti(IV) throughout the materials phase is obtained, reaching the maximal loading of Ti(IV) oxo complexes.

### Example 8

### Sensor Materials Using a Cellulose Fibril Network

Various paper towels (Tork Advanced perforated towel, white, product #HB9201) were impregnated with the titanium oxo compound shown in scheme 2.

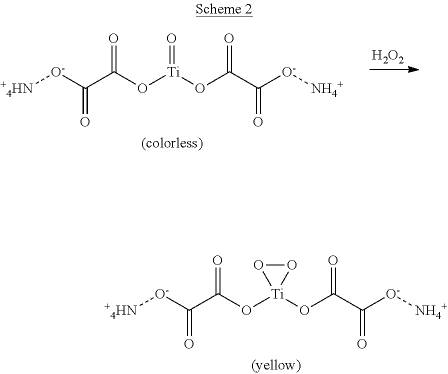

Paper sample preparation: 100 uL of the ammonium titanyl oxalate monohydrate solution of the corresponding concentration (listed below) was drop-cast onto pieces of 2.5 cm×2.5 cm towel papers and dried in vacuum at room temperature.

TABLE 1

| Resulting | Ammonium titanyl oxalate monohydrate salt/ |
|---|---|
| Titanyl Salt | Ammonium titanyl oxalate monohydrate solution |
| Concentration | dilute to 1 mL with deionized water |
| 1 mol/L | 294.0 mg Ammonium titanyl oxalate monohydrate salt |
| 0.8 mol/L | 235.2 mg Ammonium titanyl oxalate monohydrate salt |
| 0.4 mol/L | 117.6 mg Ammonium titanyl oxalate monohydrate salt |
| 0.2 mol/L | 0.2 mL 1 mol/L Ammonium titanyl oxalate |
| | monohydrate solution |
| 0.1 mol/L | 0.1 mL 1 mol/L Ammonium titanyl oxalate |
| | monohydrate solution |
| 0.05 mol/L | 0.5 mL 0.1 mol/L Ammonium titanyl oxalate |
| | monohydrate solution |
| 0.02 mol/L | 0.1 mL 0.2 mol/L Ammonium titanyl oxalate |
| | monohydrate solution |
| 0.01 mol/L | 0.1 mL 0.1 mol/L Ammonium titanyl oxalate |
| | monohydrate solution |
| 0.005 mol/L | 0.5 mL 0.01 mol/L Ammonium titanyl oxalate |
| | monohydrate solution |
| 0.001 mol/L | 0.1 mL 0.01 mol/L Ammonium titanyl oxalate |
| | monohydrate solution |

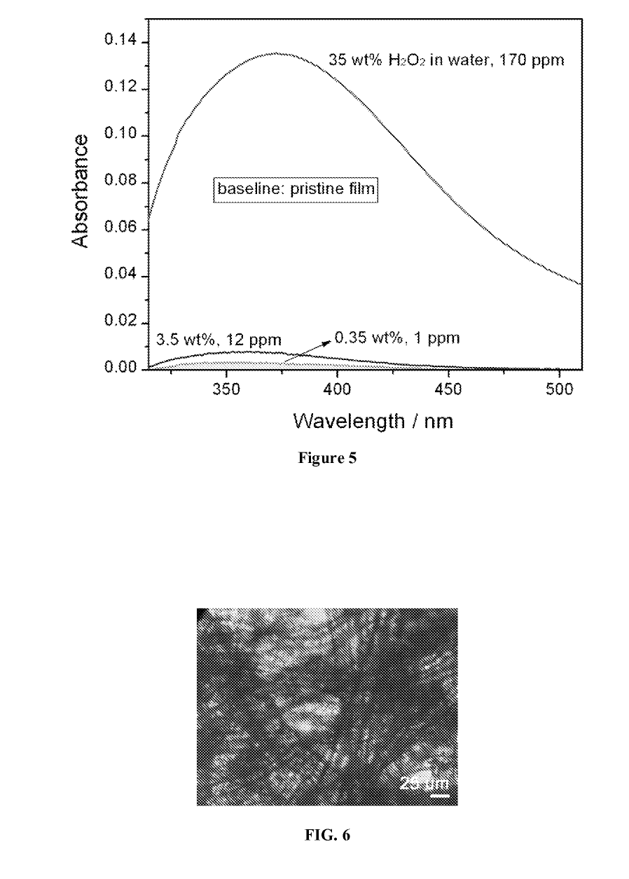

FIG. 6 provides an optical photograph of a piece of the paper towel (Tork Advanced perforated Towel, white, product #HB9201) as employed in the present sensor showing the cellulose fibril network.

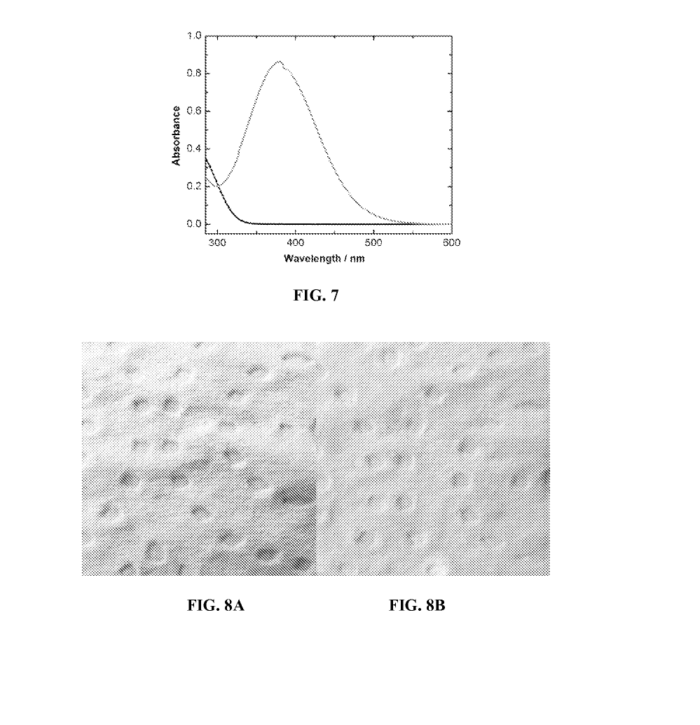

FIG. 7 provides a UV-vis absorption spectra of a water solution of the titanyl oxalate (3.9×10⁻⁴ M) before (partially dotted) and after (solid) addition of 0.04 wt % H₂O₂. Notably, the UV-vis shows that the Ti(IV) complex was intrinsically colorless (i.e., with no absorption in the visible region), whereas it turned to bright yellow upon complexation with hydrogen peroxide through formation of the Ti(IV)-peroxide bond, which exhibits strong absorption around 400 nm.

FIG. 8 is a photograph of the cellulose fibril network loaded with 100 μmol of ammonium titanyl oxalate before (left) and after (right) exposure to vapor of hydrogen peroxide (35 wt % H₂O₂ solution) for 5 min. Notably, the before picture is white while the after picture is bright yellow. As such, the present cellulose fibril-based sensor can provide a cheap, effective, disposable sensor material.

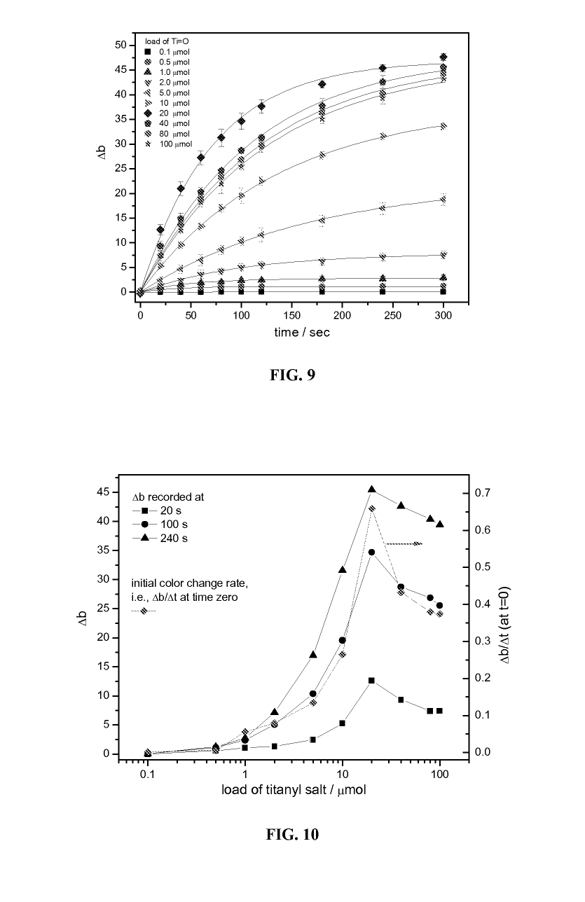

FIG. 9 is a series of plots of Δb (defined in the CIELAB color space system as color change between yellow and blue) vs. Δt for varying amounts (μmol) of titanyl salts. Time course of the yellow color formation as measured over the paper towel loaded with the titanyl salt (>Ti═O) using a CR-10 color reader (from Konica Minolta). Δb refers to the color change between yellow and blue as defined in the CIELAB color space system. Shown in FIG. 9 are the series of measurements performed over the paper towels (2×2 cm) loaded with varying amounts (μmol) of titanyl salt (ammonium titanyl oxalate monohydrate) upon exposure to the saturated vapor of 35 wt % aqueous solution of H₂O₂. The data fitting was based on the reaction kinetics equation: color change Δb=K′ (1-e^{-Kt}), where K and K′ are constants with K related to the given vapor pressure of H₂O₂ and the total load of titanyl salt and K′ referred to as the ratio of the color density to the molar amount of surface complexed hydrogen peroxide. From this equation, the color change rate (Δb/Δt)=K′K e^{-Kt}; at time zero (t=0), giving Δb/Δt=K′K. Since both K and K′ can be deduced from the fitting as shown in FIG. 9, the initial color change (formation) rate (value of Δb/Δt at t=0) was obtained for the paper towel with different level of titanyl salt loading.

For the measurements at fixed vapor of H₂O₂ (FIG. 9), the vapor test was performed by hanging the sensory paper towel in the vapor phase in a sealed 50 mL vial containing 10 mL 35%(w/w) H₂O₂ solution (where vapor pressure of H₂O₂ is 225.4 ppm), for which the color evolved was read out by the color reader at various time intervals. Error bar was standard deviation of the data.

FIG. 10 shows a plot of color change (Δb) recorded at three time intervals (20, 100, 240 s) as a function of the load of titanyl salt with an additional plot (right axis) of the initial color change (formation) rate (value of Δb/Δt at t=0, as obtained from FIG. 9). From the data shown in FIG. 9, the color change (Δb) was recorded at three time intervals (20, 100, 240 s) as a function of the load of titanyl salt. Initially, the color change as recorded as a given time increases with an increase in the load of titanyl salt. After passing the loading level of ca. 20 μmol, further increase of the amount of titanyl salt led to decrease in the color change, i.e., detrimental to the adsorption and complexation of hydrogen peroxide. Without being bound to any particular theory, this may be due to an excess of titanyl salt blocking the porosity of the paper, thus causing decrease of the surface area for vapor exposure. Plotted in the same figure (right axis) is the initial color change (formation) rate (value of Δb/Δt at t=0, as obtained from FIG. 9) as a function of the load of titanyl salt, which obviously demonstrates the same trend of change with a maximum around the loading level of 20 μmol. The color change rate represents a parameter that directly relates to the response speed of a sensor material, while the absolute value of color change (Δb) recorded at a given time is usually used for evaluating the sensitivity or detection limit. Notably, plots based on both these two considerations give the same optimal value of the load of titanyl salt, 20 μmol. In the following tests, all the paper towels were loaded with this amount of titanyl salt, with the aim to detect diluted hydrogen peroxide vapor.

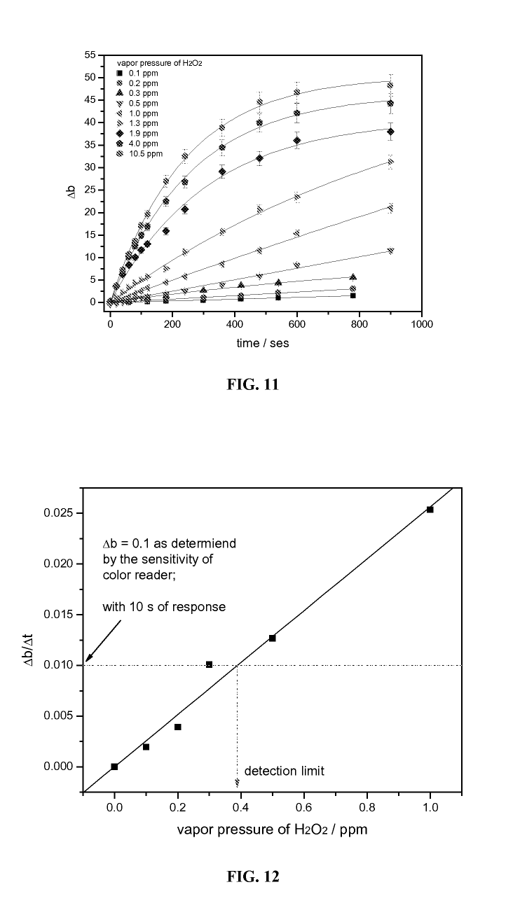

FIG. 11 is a series of plots of Δb (defined in the CIELAB color space system as color change between yellow and blue) vs. Δt for various vapor pressures of hydrogen peroxide. Time course of the yellow color formation was measured over the paper towel (2×2 cm) loaded with the fixed amount of titanyl salt (ammonium titanyl oxalate monohydrate, 20 μmol) using a CR-10 color reader (from Konica Minolta). Shown in FIG. 11 are the series of measurements performed under different vapor pressures of H₂O₂, which were obtained by diluting the 35 wt % aqueous solution of H₂O₂ into water. The data fitting was based on the same reaction kinetics equation shown in FIG. 9, color change Δb=K′ (1-e^{-Kt}). It can be clearly seen from FIG. 11 that the higher the vapor pressure of hydrogen peroxide, the faster the color forms, and the higher the value of color change (Δb) upon saturation (i.e., reaching the adsorption equilibrium), consistent to the Langmuir adsorption isotherms and the surface adsorption kinetics. When the vapor pressure of H₂O₂ is low, i.e., around or below 1.0 ppm, it took much longer time to reach the equilibrium plateau, and notably, within the early time regime (e.g., 900 s as investigated here) Δb changes almost linearly with time. This is not surprising, if considering the small value of Kt, and thus the kinetics equation above Δb=K′ (1-e^{-Kt}) can be simplified to be Δb=K′ K t (i.e., linear time dependence). Therefore, for the low vapor pressures of H₂O₂, the slope Δb/Δt=K′ K. Since K is proportional to the vapor pressure, it is expected that Δb/Δt should be linearly dependent on the vapor pressure of H₂O₂ (as indeed evidenced in FIG. 12).

For the measurements at fixed load of titanyl salt (FIG. 11), approximately 1 L of various diluted H₂O₂ solution (with corresponding vapor pressures as listed below in Table 2 and in FIG. 11) was put in a 10 L sealed container and allows for equilibrium for 12 hours. The sensor paper towel was attached facing closely to the center of the fan and hang in the vapor phase in the sealed container (about 20 cm above the solution surface). The sample was blown (12V, 6500RPM) for various time intervals (as shown in FIG. 11) before taken out for color reading. Error bar was 5% value of the data point.

### Preparation of Different Concentrations of H₂O₂ Solutions:

TABLE 2

| | # of mL of 35%(w/w) hydrogen |
|---|---|
| Resulting | peroxide solution diluted to 1 L |
| Vapor Pressure | with deionized water and |
| of H₂O₂ (ppm) | equilibrium for 12 hours |
| 10.5 | 100 |
| 4 | 40 |
| 1.9 | 20 |
| 1.3 | 13.3 |
| 1.0 | 10 |
| 0.5 | 5 |
| 0.3 | 3.3 |
| 0.2 | 2 |
| 0.1 | 1 |

FIG. 12 is a plot of Δb/Δt vs. vapor pressure of H₂O₂. For the data of FIG. 11 under the low vapor pressures of H₂O₂ (0.1, 0.2, 0.3, 0.5 and 1.0 ppm), Δb is linearly dependent on the time following the equation Δb=K′ K t. The slope (Δb/Δt) as extracted from each of the plots in FIG. 11 can be re-plotted as a function of the vapor pressure of H₂O₂, as shown in this Figure, which gives a linear relationship (as expected and analyzed above in FIG. 11) with a fitting correlation coefficient of 0.99. Considering the measurement sensitivity (Δb=0.1) of the color reader, and if allowing for a detection response time of 10 seconds, we have Δb/Δt=0.01, which corresponds to a vapor pressure of 0.4 ppm as indicated in the plot. While this value (corresponding to 250 times dilution of the commercial 35 wt % H₂O₂ solution) can be roughly considered as the detection limit for the vapor of hydrogen peroxide under the current measurement conditions, by utilizing general improvements as discussed herein, e.g. a dual mode sensor or a closed detector system (for maximized vapor sampling), the detection limit is expected to be in the lower ppb range.

For the present data, UV-vis absorption spectra were measured on a PerkinElmer Lambda 25 spectrophotometer. Microscopy imaging was carried out with a Leica DMI4000B inverted microscope. The Ammonium titanyl oxalate monohydrate was purchased from Fisher.

Color reader CR-10 was purchased from Konica Minolta Sensing Americas, Inc(minus value 0.1). The towel paper was purchased from SAFECHEM (Tork Advanced perforated Towel (white), HB9201). The fan used for vapor exposure was purchased from Radio Shack (40 mm, 12DVC, 6500RPM).

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A sensor for detecting explosives, comprising
a porous hydrophilic material modified with a titanium oxo compound having the following structure: 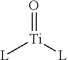
where L is a ligand;
wherein the porous hydrophilic material is capable of detecting hydrogen peroxide vapor by complexing the titanium oxo compound with the hydrogen peroxide to provide a color change.

2. The sensor of claim 1, wherein the porous hydrophilic material is a thin film.

3. The sensor of claim 1, wherein the porous hydrophilic material comprises a cellulose fibril material.

4. The sensor of claim 1, wherein the porous hydrophilic material is a nanofiber surface-modified with the titanium oxo compound.

5. The sensor of claim 1, wherein the ligand is selected from the group consisting of:
carboxylate, sulfate, hydroxyl (—OH) and combinations thereof.

6. The sensor of claim 1, wherein the hydrogen peroxide vapor is less than 1 ppm.

7. The sensor of claim 1, wherein the hydrogen peroxide vapor is present in an amount of about 1 ppb to about 100 ppb.

8. The sensor of claim 1, wherein the sensor detects peroxide based explosives.

9. The sensor of claim 1, wherein the explosives include a compound selected from the group consisting of triacetone triperoxide, diacetone diperoxide, hexamethylene triperoxide diamine, and mixtures thereof.

10. The sensor of claim 1, wherein the porous hydrophilic material modified with the titanium oxo compound provides a visual color change upon exposure to the hydrogen peroxide.

11. The sensor of claim 1, further comprising a colorimetric detector associated with the porous hydrophilic material configured to measure the color change.

12. The sensor of claim 1, wherein the sensor is disposable.

13. A method for detecting explosives, comprising placing a porous hydrophilic material modified with a titanium oxo compound in an area having hydrogen peroxide vapor; the titanium oxo compound having the following structure: 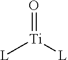
where L is a ligand; wherein the porous hydrophilic material is capable of detecting of the hydrogen peroxide vapor by complexing the titanium oxo compound with the hydrogen peroxide to provide a color change; and
identifying the color change.

14. The method of claim 13, wherein identifying the color change is by visual inspection.

15. The method of claim 13, wherein identifying the color change is by a colorimetric device.

16. The method of claim 13, wherein the hydrogen peroxide vapor is less than 1 ppm.

17. The method of claim 13, wherein the hydrogen peroxide vapor is present in an amount of about 1 ppb to about 100 ppb.

18. The method of claim 13, further comprising disposing the porous hydrophilic material after use.

19. A system for detecting explosives comprising:
a) a porous hydrophilic material modified with a titanium oxo compound having the following structure: 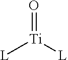
where L is a ligand; wherein the porous hydrophilic material is capable of detecting hydrogen peroxide vapor by complexing the titanium oxo compound with the hydrogen peroxide to provide a color change; and
b) a colorimetric detector associated with the porous hydrophilic material configured to measure the color change.

20. The system of claim 19, wherein the hydrogen peroxide vapor is less than 1 ppm.

21. The system of claim 19, wherein the hydrogen peroxide vapor is present in an amount of about 1 ppb to about 100 ppb.

22. The system of claim 19, wherein the porous hydrophilic material is disposable.

23. The system of claim 19, further comprising a UV irradiation source for decomposing peroxide compounds into hydrogen peroxide vapor.
